(19) United States
(12) Patent Application Publication
(10) Pub. No.: US 2006/0149451 A1
(43) Pub. Date: Jul. 6, 2006

(54) Method and device for detecting longitudinal and transversal acceleration of a vehicle

(75) Inventor: Jaochim Maas, Neu-Anspach (DE)

Correspondence Address: Craig Hallacher;Continental Teves, One Continental Drive, Auburn Hills, MI, 48326, US

(73) Assignee: Continental Teves AG & Co. oHG

(21) Appl. No.: 10/537,866

(22) PCT Filed: Dec. 19, 2003
(86) PCT No.: PCT/EP03/51084

§ 371 Date: Feb. 17, 2006

(30) Foreign Application Priority Data
Dec. 19, 2002 (DE) 102 59 539.9

(51) Int. Cl. G06F 19/00

(52) U.S. Cl. 701/70; 701/41; 702/141

(57) ABSTRACT

Disclosed is a method for detecting longitudinal and lateral acceleration of a vehicle, in which at least two sensors determine acceleration components that are aligned in a substantially perpendicular manner in relation to each other. The method is characterized in that the acceleration components have an angle ranging between 10° and 80° relative to the direction of longitudinal movement of the vehicle.

### BACKGROUND OF THE INVENTION

The present invention relates to a device for detecting longitudinal and lateral acceleration of a vehicle in which at least two sensors determine acceleration components that are aligned substantially perpendicular in relation to each other.

German published patent application DE 42 08 141 A1 discloses an anti-lock control system for motor vehicles, which includes devices for detecting the yaw angle acceleration with two acceleration sensors. The acceleration sensors have identical directions of acceleration detection and are fixedly arranged at a distance from each other in a joint plane that extends through the vehicle's point of gravity.

German patent DE 196 11 359 C1 discloses a method of preventing a vehicle at standstill from rolling away inadvertently, wherein a brake pressure is maintained in wheel brake cylinders as a roll-away prevention and wherein the maintained brake pressure depends on the application of the brake pedal, and wherein the speed of the vehicle is detected. Said prior art method is characterized in that an actuating force applied by the driver is detected as a representative variable, and wherein the brake pressure is so developed that at least a pressure necessary for retaining the vehicle is generated.

Further, the invention relates to a method, wherein a lateral acceleration of a vehicle is determined and a steering movement is influenced depending on the lateral acceleration.

Besides, the invention relates to a method of preventing a vehicle at standstill from rolling away inadvertently, wherein a brake force is maintained to prevent such rolling away and a speed of the vehicle is detected.

An object of the invention is to provide a method and a device allowing a quick and reliable determination of a vehicle's longitudinal and lateral accelerations with least possible constructive effort.

### SUMMARY OF THE INVENTION

According to the invention, this object is achieved by a method wherein two acceleration components aligned in a substantially perpendicular manner in relation to each other are determined, and with at least one of the acceleration components having an angle ranging between 10° and 80° relative to the direction of longitudinal movement of the vehicle.

A particularly preferred embodiment of the invention is characterized in that at least one acceleration component is determined at an angle of roughly 45° relative to the direction of longitudinal movement of the vehicle.

The acceleration value is determined by way of the equations
Mess1=a_{q}*cos η−g*sin η (1)
Mess2=a_{q}*cos η+g*sin η, (2)
where a_{q} refers to a lateral acceleration of the vehicle, η to an angle between the direction of longitudinal acceleration and a sensing direction of an acceleration component and a₁ to the longitudinal acceleration.

A deviation component k compared to the expected

$$k = 2 a tan [ \frac{1}{\frac{Δ}{2 g η} + 1} * ( \frac{\sum }{2 g} + \sqrt{{( \frac{\sum }{2 g} )}^{2} - 1 + {( \frac{Δ}{2 g η} )}^{2}} ) ]$$

is achieved by a transformation corresponding to the calculation steps illustrated in European patent EP 0 769 701 B1.

The invention also arranges for the application of an evaluation unit. The evaluation unit brings about a logical operation of the measuring data sensed by the sensors and analyzed. Suitably, the logical operation is carried out so that longitudinal acceleration values and lateral acceleration values are determined. It is especially appropriate to determine lateral acceleration values in at least two different ways. The redundancy of the acceleration values is advantageous in particular when important vehicle functions are controlled depending on these values. This is especially favorable when a steering movement or a brake force of the vehicle shall be controlled.

According to a particularly preferred embodiment of the invention, a method for controlling a steering movement of a vehicle wherein lateral acceleration of the vehicle is determined and the steering movement is controlled depending on the lateral acceleration, is carried out in such a way that the lateral acceleration is determined by taking into consideration acceleration components, with the acceleration components having an angle ranging between 10° and 80° in relation to the direction of longitudinal movement of the vehicle.

In another, equally preferred embodiment of the invention, a method for preventing a vehicle at standstill from rolling away inadvertently, wherein a brake pressure is maintained in wheel brake cylinders as a roll-away prevention and wherein a speed of the vehicle is detected, is implemented in such a manner that the brake force is controlled depending on a longitudinal acceleration of the vehicle and that the longitudinal acceleration is determined taking into consideration acceleration components, with the acceleration components having an angle ranging between 10° and 80° in relation to the direction of longitudinal movement of the vehicle.

Further advantages, special features and appropriate improvements of the invention can be taken from the sub claims and the following description of preferred embodiments of the invention by making reference to the accompanying drawing.

### BRIEF DESCRIPTION OF THE DRAWINGS

In the drawings:

FIG. 1 is a diagrammatic view of a prior art arrangement of acceleration sensors.

FIG. 2 is a diagrammatic view of an arrangement of the acceleration sensors according to the invention.

### DETAILED DESCRIPTION OF THE DRAWINGS

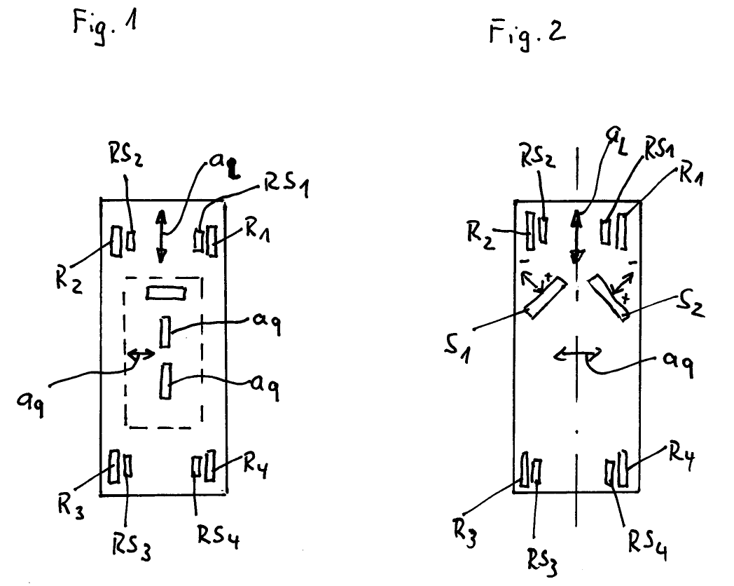

FIG. 1 shows a vehicle having a sensor assembly as shown in the state of the art. The prior art sensor assembly is characterized by the provision of at least one acceleration sensor for measuring a longitudinal acceleration and at least two further sensors for the independent measurement of lateral acceleration values.

FIG. 2 shows a vehicle equipped with a sensor assembly according to the invention. The vehicle is in particular a ground vehicle, preferably a passenger car or an automotive truck.

The vehicle has wheels R₁, R₂, R₃ and R₄. Several of the wheels are driven. The invention can be used irrespective of the number of the driven wheels and, therefore, lends itself to an application in vehicles with rear-wheel drive, and with front-wheel drive or all-wheel drive.

Preferably, several or all of the wheels R₁, R₂, R₃ and R₄ include wheel sensors RS₁, RS₂, RS₃ and RS₄. The wheel sensors RS₁, RS₂, RS₃ and RS₄ measure rotational speeds and rotational accelerations of the individual wheels R₁, R₂, R₃ and R₄.

Several or all of the wheels R₁, R₂, R₃ and R₄ are driven by a motor or by several motors, which are not illustrated for the sake of clarity.

Further, several or all of the wheels R₁, R₂, R₃ and R₄ are equipped with brakes. The brakes are controlled depending on control commands of a driver of the vehicle and on control circuits provided in the vehicle, in particular anti-lock or traction slip control systems.

The vehicle experiences a positive or negative longitudinal acceleration along depending on the forces transmitted to the wheels.

Further, the vehicle includes two sensors S₁ and S₂ being arranged in a substantially perpendicular manner relative to each other. Sensors S₁ and S₂ are configured in such a manner that they determine acceleration values in one sensing direction respectively. In this arrangement, the sensors are aligned so that they have in each case an angle ranging between 10° and 80°, preferably about 45°, in relation to the main direction of movement of the vehicle.

The acceleration sensors shown in FIG. 2 have an angle of 90° with respect to each other and an angle of 45° with respect to the main direction of movement of the vehicle. The measurement direction of the sensors covers an angle of roughly 45° with respect to the main direction of movement of the vehicle.

A comparison between the test values of the two sensors S₁ and S₂ and inclusion of the respective signs of the acceleration components determined by the sensors S₁ and S₂ renders it possible to determine an appearing lateral acceleration. Also, the longitudinal acceleration along is determined from the combination of the test values of sensors S₁ and S₂.

In particular, the invention is appropriate to prevent the vehicle from rolling away when driving uphill, to control active steering operations and for use in electronic stability control systems.

Especially preferred embodiments of the invention comprise methods for controlling the driving stability of the vehicle, wherein the input quantities being essentially defined by the curve of driving desired, are converted into the nominal value of a yaw rate on account of a vehicle model predetermined by operands, and the nominal value is compared in a comparator with an actual value of the yaw rate determined by means of a sensor. The differential value found is sent to a control and a torque variable is calculated that is used to determine pressure quantities, which through the wheel brakes of the vehicle generate an additional yaw torque adapting the measured yaw rate to the calculated yaw rate.

It is particularly favorable to use targeted interventions on the brakes of individual wheels R₁, R₂, R₃ and R₄ to produce negative longitudinal accelerations (braking operations) or additional torques which adapt an actually measured yaw rate of the vehicle to a yaw rate predetermined by the driver.

With an implementation for controlling the steering performance by means of a targeted braking of the wheels and/or a targeted change of a steering intervention into an angular position of one or more of the wheels, it is possible to bring the actual resultant torque in conformity with a desired torque.

1. A method for detecting longitudinal and lateral acceleration of a vehicle, in which at least two sensors determine acceleration components that are aligned in a substantially perpendicular manner in relation to each other,
characterized in that the acceleration components have an angle ranging between 10° and 80° relative to the direction of longitudinal movement of the vehicle.

2. The method as claimed in claim 1,
characterized in that at least one of the acceleration components is determined at an angle of roughly 45° relative to the direction of longitudinal movement of the vehicle.

3. The method as claimed in any one or both of claims 1 to 2,
characterized in that an evaluation unit determines the actual longitudinal acceleration and an appearing lateral acceleration by way of a comparison between an expected longitudinal acceleration and the measured acceleration components.

4. A method for controlling a steering movement of a vehicle wherein a lateral acceleration of the vehicle is determined and the steering movement is controlled depending on the lateral acceleration,
characterized in that the lateral acceleration is determined by taking into consideration acceleration components, with the acceleration components having an angle ranging between 10° and 80° in relation to the direction of longitudinal movement of the vehicle.

5. A method for preventing a vehicle at standstill from rolling away inadvertently, in which a brake pressure is maintained in wheel brake cylinders as a roll-away prevention and in which a speed of the vehicle is detected,
characterized in that the brake force is controlled depending on a longitudinal acceleration of the vehicle and in that the longitudinal acceleration is determined taking into consideration acceleration components, with the acceleration components having an angle ranging between 10° and 80° in relation to the direction of longitudinal movement of the vehicle.

6. A device for detecting a longitudinal and a lateral acceleration of a vehicle including at least two sensors that are aligned in a substantially perpendicular manner in relation to each other, and an evaluation unit,
characterized in that the sensors are so aligned that their sensing direction has an angle ranging between 10° and 80° relative to the direction of longitudinal movement of the vehicle.

7. The device as claimed in claim 6,
characterized in that the sensors are so aligned that their sensing direction has an angle of roughly 45° relative to the direction of longitudinal movement of the vehicle.
